(19) United States
(12) Patent Application Publication
(10) Pub. No.: US 2018/0053269 A1
(43) Pub. Date: Feb. 22, 2018

(54) REAL-ESTATE TRANSACTION MANAGEMENT PLATFORM

(71) Applicants: Jason Heatherly, Lake Worth, FL (US); Casey Heatherly, Lake Worth, FL (US)

(72) Inventors: Jason Heatherly, Lake Worth, FL (US); Casey Heatherly, Lake Worth, FL (US)

(21) Appl. No.: 15/591,184

(22) Filed: May 10, 2017

Related U.S. Application Data
(60) Provisional application No. 62/376,484, filed on Aug. 18, 2016.

(51) Int. Cl. G06Q 50/16; G06Q 30/06

(52) U.S. Cl. CPC G06Q 50/16; G06Q 30/0619

(57) ABSTRACT

A method and system for connecting users of a real-estate transaction management platform for conducting real-estate transactions, is provided. The geographic locations of user computing devices, and current status of the one or more corresponding users are received. Then, nearby listed real-estate properties, and nearby active users, for a first active user are automatically determined based on a current geographical location of the first active user, pre-defined preferences of the first user, and a time duration for which the first user is active. Then, locations of the determined real-estate properties and nearby active users are displayed on a map interface of a computing device of the first user. Finally, the first user is enabled to communicate with the determined nearby active users, and users corresponding to the determined real-estate properties.

### TECHNICAL FIELD

The present invention herein relate to a real-estate transaction management platform. More particularly, to a real-estate transaction management platform, that connects licensed real estate professionals, money lenders, and buyers based on their location information in a given time duration.

### BACKGROUND

Real-estate transactions typically involve many participants, including buyers, sellers, agents, brokers, real-estate developers, property owners, loan officers, and money lenders. Each participant typically maintains various information about the real-estate properties for which they are involved in a transaction.

Conventional Internet based real-estate platforms provide limited ways to search for properties, such as, for example, searching by address, by number of rooms, by price range, etc. Such search limitations make it difficult for some buyers/tenants to find real-estate properties in which they may have interest. They are required to search for long to find the property as per their preferred location. Upon finding the property, it is required by them to look around for the licensed brokers and the loan lenders for carrying out property transaction. The potential buyers/tenants may also be required to check with various loan lenders to get the best price, deals and do the best possible negotiations.

Similarly, a commercial real estate agent attempts to identify and match the property space requirements of a potential tenant/buyer with the represented property owner. Even after the agent/buyer is successful in identifying and matching a property, the transaction is far from complete. In order to complete the transaction, the real-estate agent may often engage the services of money lenders and loan officers. In addition, the credit worthiness of the potential tenant/buyer must be researched and verified.

Thus, the conventional method of connecting lenders/sellers/buyers for property transaction, and the entire process of buying or selling the property or renting the property is very lengthy and time consuming. At times, this whole process may extend over couple of days, weeks or months.

Hence, there is a need for an internet-based real-estate transaction platform that overcomes the limitations of existing systems, connects the buyers/real-estate agents/money lenders in a novel and efficient manner, provide an organized chain of professional brokers and lenders, where the potential buyers can select the best deal as per their requirements.

### SUMMARY

According to an aspect of the present invention, there is provided a method for connecting one or more users of a real-estate transaction management platform for conducting one or more real-estate transactions. At a server device, one or more geographic locations of one or more user computing devices, and current status of the one or more corresponding users are received. Then, one or more nearby listed real-estate properties, and one or more nearby active users, for a first active user are automatically determined by the server device, based on a current geographical location of the first active user, one or more pre-defined preferences of the first user, and a time duration for which the first user is active. Then, one or more locations of the determined one or more real-estate properties and one or more nearby active users are displayed on a map interface of a computing device of the first user. Finally, the first user is enabled to communicate with the determined one or more nearby active users, and one or more users corresponding to the determined one or more real-estate properties.

According to another aspect of the present invention, there is provided a system for connecting one or more users of a real-estate transaction management platform for conducting one or more real-estate transactions. The system includes a processor, and a memory storing a program for execution by the processor. The program includes instructions for receiving one or more geographic locations of one or more user computing devices, and current status of the one or more corresponding users; automatically determining one or more nearby real-estate properties listed on the real-estate transaction management platform, and one or more nearby active users, for a first active user, based on a current geographical location of the first active user, one or more pre-defined preferences of the first user, and a time duration for which the first user is active; displaying one or more locations of the determined one or more real-estate properties and one or more nearby active users, on a map interface of a computing device of the first user; and enabling the first user to communicate with the determined one or more nearby active users, and one or more users corresponding to the determined one or more real-estate properties.

According to yet another aspect of the present invention, there is provided a non-transitory computer readable storage medium storing a program configured to be executed by a processor for connecting one or more users of a real-estate transaction management platform for conducting one or more real-estate transactions. The program comprises instructions for receiving one or more geographic locations of one or more user computing devices, and current status of the one or more corresponding users; automatically determining one or more nearby real-estate properties listed on the real-estate transaction management platform, and one or more nearby active users, for a first active user, based on a current geographical location of the first active user, one or more pre-defined preferences of the first user, and a time duration for which the first user is active; displaying one or more locations of the determined one or more real-estate properties and one or more nearby active users, on a map interface of a computing device of the first user; and enabling the first user to communicate with the determined one or more nearby active users, and one or more users corresponding to the determined one or more real-estate properties.

Various embodiments of the present invention provide a system of real estate on-demand service for real time networking of Licensed Real Estate Professionals and/or lender and a buyer, based on the GPS location of the property in which the buyer is interested and the parameters preferred by the buyer. The buyers can get in touch with the real-estate agents and lenders, and can select the best deal as per their requirements. The data generated with respect to the geographic location of the real estate makes it convenient for the real estate professionals, lenders and customers to locate the property. A transaction database stores the transaction details such as the agreement between the parties, rent or sale deed amount, loan amount, interest rate, payment tenures, landmark payment schedules and the similar.

Furthermore, the embodiments relate to process of connecting genuine buyers and/or renters with genuine real-estate professionals and lenders having verified property with respect to the preferred location of the buyers.

Furthermore, the embodiments relate to indicating whether a buyer is currently near a geographic location of any listed real estate for receiving an on-demand service and further determining using the interest of the buyers, who launched the service application within a designated duration of time. The time is deemed to be indicative of interest for requesting service from the on-demand service within a given geographic region of the listed real estate.

However, this summary is not an extensive overview of the disclosure. It is intended to neither identify key or critical elements of the disclosure, nor to delineate the scope of the present disclosure. Rather, the sole purpose of this summary is to present some concepts of the disclosure, its objects, and advantages in a simplified form as a prelude to the more detailed description that is presented hereinafter.

### BRIEF DESCRIPTION OF THE DRAWINGS

The foregoing summary, as well as the following detailed description of various embodiments, is better understood when read in conjunction with the drawings provided herein. For the purposes of illustration, there is shown in the drawings exemplary embodiments; however, the presently disclosed subject matter is not limited to the specific methods and instrumentalities disclosed.

FIG. 1 illustrates a system environment wherein various embodiments of the present invention can be practiced;

FIG. 2 is an exemplary home screen of a computing device of a user of the real-estate transaction management platform, in accordance with an embodiment of the present invention;

FIG. 3 illustrates exemplary first and second display screens of a computing device of a user of the real-estate transaction management platform, in accordance with an embodiment of the present invention;

FIG. 4 illustrates exemplary third and fourth display screens of a computing device of a user of the real-estate transaction management platform, in accordance with an embodiment of the present invention; and

FIG. 5 is a flowchart illustrating a method of connecting one or more users for conducting real-estate transactions, in accordance with an embodiment of the present invention.

### DETAILED DESCRIPTION

The presently disclosed subject matter is described with specificity to meet statutory requirements. However, the description itself is not intended to limit the scope of this patent. Rather, the inventors have contemplated that the claimed subject matter might also be embodied in other ways, to include different steps or elements similar to the ones described in this document, in conjunction with other present or future technologies.

It is to be understood that both the foregoing general description and the following detailed description are exemplary and explanatory only, and are not restrictive of the disclosure, as claimed. In this application, the use of the singular includes the plural, the word “a” or “an” means “at least one”, and the use of “or” means “and/or”, unless specifically stated otherwise. Furthermore, the use of the term “including”, as well as other forms, such as “includes” and “included”, is not limiting. Also, terms such as “element” or “component” encompass both elements and components comprising one unit and elements or components that comprise more than one unit unless specifically stated otherwise.

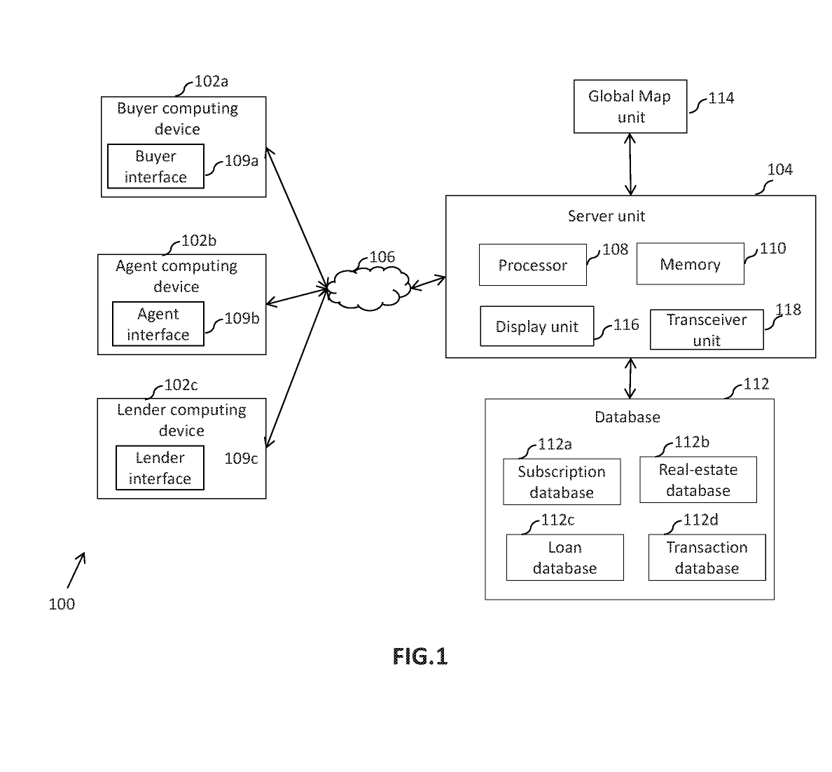

FIG. 1 illustrates a system environment 100 wherein various embodiments of the present invention can be practiced. The system environment 100 includes a buyer computing device 102a, an agent computing device 102b, and a lender computing device 102c (hereinafter collectively referred to as computing devices 102) communicatively coupled to each other, and to a server unit 104 through a communication network 106.

Examples of the computing devices 102 include, but are not limited to, a smart phone, a laptop, a personal digital assistant, a laptab, and a tab. Each computing device 102 may be enabled with Global Positioning Service (GPS) functionality to automatically know and transmit corresponding user location. It will be apparent to a person skilled in the art that further computing devices 102 may be added to the system environment 100, without limiting the scope of the disclosure.

Examples of the communication network 106 include, but are not limited to, a Local Area Network (LAN), a cellular network, a Wide Area Network (WAN), a Wi-Fi network, and any other network that provides data connectivity among various computing devices.

The buyer computing device 102a is to be used by a buyer interested in buying or renting a real estate property. The buyer in the context of this disclosure may include an individual actually interested in acquiring the real-estate property to be sold, or an individual merely curious about the real-estate property, or a representative of an individual who is interested in acquiring the real-estate property to be sold, and so on.

The agent computing device 102b is to be used by a real-estate agent/broker. The real-estate agent/broker in the context of this disclosure may include anyone who furnishes the buyer with the opportunity to purchase/rent the real-estate property. Examples of the real-estate agent/broker may include a current owner of the real-estate property, a representative or agent of the real-estate property.

The lender computing device 102c is to be used by a money lender. The money lender in the context of this disclosure may include a person who can provide access to funds, whether it is for debt or equity. Examples of the money lender, include, but are not limited to, banks, loan officers, venture capitalists, or the like.

The server unit 104 includes a set of instructions and/or interfaces embodied on a computer readable medium for execution on a processor 108, for providing a real-estate transaction management platform for enabling the buyer, broker and the lender to connect and manage their real-estate transactions. One example is a computer program stored on a non-transitory, tangible memory device 110, such as a hard drive or some form of programmable read only memory device. The server unit 104 includes at least one processor 108 for operating the computer program, and at least one database 110 connected to the at least one processor. Alternatively, the server unit 104 could be a network of computers all operating according to the instructions of the computer program. In one embodiment, the at least one database 110 may be external to the server unit 104.

In one embodiment, each of the buyer, agent, and lender may download and install a service application of the server unit 104 onto corresponding computing devices 102a, 102b and 102c, to access the real-estate transaction management platform and manage real-estate transactions in real-time.

The service application is configured to provide user-specific interfaces based on user login type, for example, the service application executing in the buyer computing device 102a displays a buyer interface 109a on respective display screen, the service application executing in the agent computing device 102b displays an agent interface 109b on respective display screen, and the service application executing in the lender computing device 102c displays a lender interface 109c on respective display screen.

The server unit 104 is further coupled to the database 112 which may be either internal or external to the server unit 104. The database 112 may include a subscription database 112a, a real-estate database 112b, a loan database 112c, and a transaction database 112d.

In one embodiment, the real estate agents and the lenders are required to subscribe to the real-estate transaction management platform before exchanging their contact details with the buyers. Examples of the details include, but are not limited to, login id, password, duration of subscription and the similar. The details of the subscription may be stored in the subscription database 110a.

In one embodiment, the agent interface 109b enables a respective agent to upload the details of one or more authorized real-estate properties, and other related information along with their registration number, contact details and the similar necessary information. The property details may preferably include a location of the property, a number of rooms, furnishing details, availability dates, the pricing, and one or more images and videos of the property. Here, the term “uploading” means either saving some documents or files on the server unit 104 as well as writing texts or numerical or providing input using the input device such as keyboard or stylus. In one embodiment, the information uploaded through the agent interface 109b is saved in the real estate database 110b. The real-estate database 110b stores a location, price range, facilities, number of rooms, images, videos of each listed real-estate property.

In one embodiment, the buyer interface 109a enables a respective buyer to subscribe to the real-estate transaction management platform by uploading a valid identification proof, system account related credentials (username-password, thumb scanning) to make sure that the buyer is real. The buyer interface 109a further enables the buyer to upload their preferred property requirements, as well as browse the listed properties. The property requirement details may preferably include a location of property, a number of rooms, furnishing details, date from which they need property and their budget range.

In one embodiment, the lender interface 109c enables a respective lender to upload the details of various loan schemes, term and conditions available for various real estate properties listed by the real-estate agent. In one embodiment, the information uploaded through the lender interface 109c regarding the loan products and offers is saved in the loan database 110c. The information uploaded regarding the load products and offers may preferably include an amount of loan possible on a real-estate property, EMI options available, rate of interest and the similar.

In one embodiment, the transactional database 110d stores the transaction details of one or more real estate properties. In one embodiment, the information uploaded in the transaction database 110d shall preferably include a sale/rent agreement between the parties, rent or sale deed amount, loan amount, interest rate, payment tenures, landmark payment schedules and the similar. In one embodiment, the details can be stored in the transaction database 110d through at least one of the buyer interface 109a, agent interface 109b and the lender interface 109c.

The system environment 100 further includes a global map unit 114 communicatively coupled to the server unit 104 for generating latitude and longitude data associated with geographic location of the real-estate properties stored in the real-estate database 112b. The global map unit 114 enables display of location one or more real-estate properties and one or more users on a global map. The data generated with respect to the geographic location of the real estate properties makes it convenient for the real estate professionals, lenders and customers to locate a property, and also each other.

In one of the preferred embodiment, the server unit 104 may include one or more processors for the processing of information received from the user interfaces 109a, 109b, and 109c, and storing the same processed information in respective database units 112a, 112b, 112c and 112d. Further, the processors may be associated with one or more memory resources for storing the information required for the processing of the uploaded information. The server unit 104 may be provided with a display unit 116 for displaying the information requested by the user interfaces 109a, 109b and 109c.

In one of the preferred embodiment, the memory resources 110 are coupled to the processors 108. Further, the memory resources 110 are used for storing instructions for the processors 108 to run the real-estate transaction management platform. Further, the instruction saved in the memory resources 110 cause the server unit 104 to receive user request data from the computing devices 102 that are operated by users and generated by a service application on respective computing devices 102.

Similarly, the instruction saved in the memory resources 110 cause the server unit 104 to receive professional/broker/dealer data from the computing devices 102 that are operated by respective subscribed professional/broker/dealer and generated by a service application on the respective computing device 102. The received subscribed professional/broker/dealer data includes position information from the respective computing device and other subscription related information. Further, the instruction saved causes the server unit 104 to receive real estate data from the global map unit 114, the data comprising latitude data and a longitude data associated with the geographic location of the real estates stored in the real-estate database 112b.

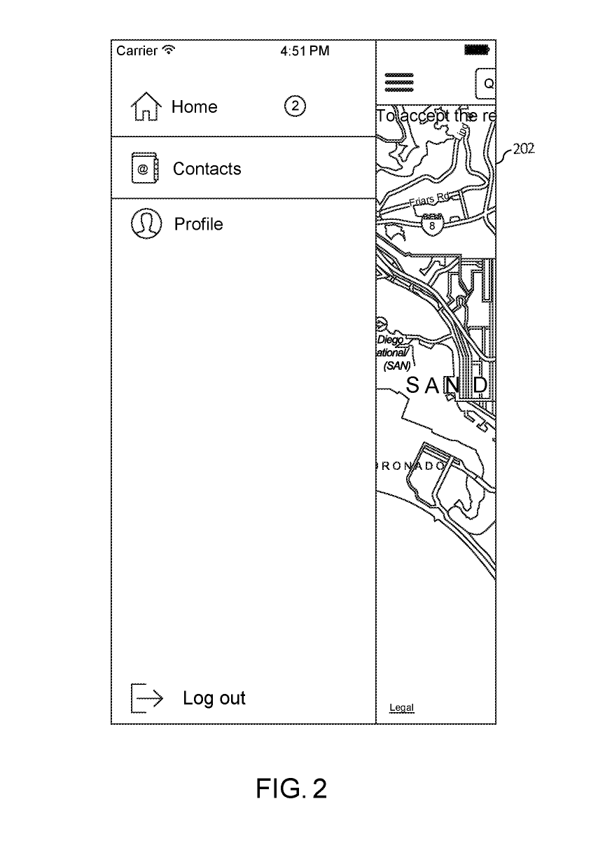

FIG. 2 is an exemplary home screen 200 of a computing device of a user of the real-estate transaction management platform, in accordance with an embodiment of the present invention.

The user may be either a buyer, a real-estate agent or a lender registered with the real-estate transaction management platform provided by the server unit 104. The home screen 200 displays an icon to reach to a home page, an icon to access contacts in a user network. The contacts in the user network may include potential buyers, real-estate agents, and money lenders. The home screen 200 further displays an icon to access a user profile. The user profile may include a user name, user contact details, type of user, previous transactions, images, videos, and the like. The right side of the home screen 200 displays a map, which may display a current location of the user on the map.

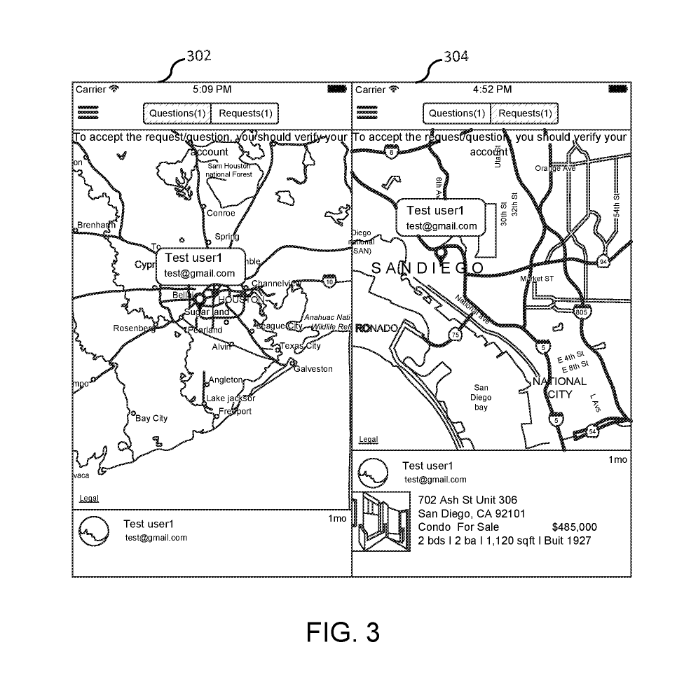

FIG. 3 illustrates exemplary first and second display screens 302 and 304 of a computing device of a user of the real-estate transaction management platform, in accordance with an embodiment of the present invention.

The first display screen 302 displays a map illustrating real-time locations of the one or more users subscribed to the real-estate transaction management platform. The second display screen 304 displays a zoomed-in view of the map of the first display screen 302.

The second display screen 304 displays a real-time location of the user, an address of the user, queries and requests received by the user. The real-time location of the user may be used to determine whether the user is currently near the geographic location of any listed real estate for receiving an on-demand service. Also, based on the interest and profile of the user, the location of the nearby active users may also be displayed on the map. The active users may be the ones who launch the service application within a designated duration of time. The time is deemed to be indicative of interest for requesting service from the on-demand service within a given geographic region of the listed real estate.

For example, if the user is a buyer and is online at 4:52 pm and is present in a particular geographic region, then the server unit 104 may be configured to define a time range such as 10 min, and an area around the geographic region such as 2 km², and then determine real-estate properties of user interest, and agents/money lenders who are online in the geographic region during that time range, and display location of the determined real-estate properties and active agents/money lenders on the map interface. As the buyer changes its location, the server unit 104 is configured to automatically determine and display a new set of real-estate properties and active agents/money lenders on the map. The map interface further enables the buyer to contact the active agents/money lenders displayed on the map, and receive queries/requests.

Similarly, if the user is a real-estate agent and is active in a geographic region in a given time frame, the server unit 104 may be configured to automatically determine the prospective buyers and money lenders in the geographic region in the given time duration.

In one of the preferred embodiment, automatically displaying location of nearby real-estate properties, and nearby users on a map interface, and enabling the user to connect to other users is an on-demand service and is made available to the user, upon payment of a subscription fees. However, general browsing of the real-estate properties and other agents/buyers/lenders is a feature that is free of cost available to registered users.

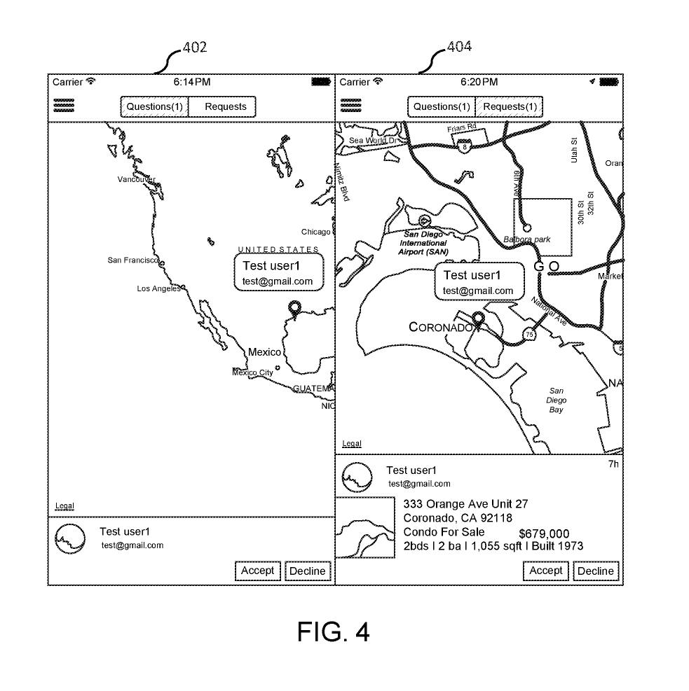

FIG. 4 illustrates exemplary third and fourth display screens 402 and 404 of a computing device of a user of the real-estate transaction management platform, in accordance with an embodiment of the present invention.

The third and fourth display screens 402 and 404 display different locations of the user at different time instants. For example, at 6:14 pm, the user may be at a particular location and has received one question and zero request. At 6:20 pm, the user may receive one request from nearby users based on the user location. If the user is a real-estate agent, then the query may pertain to a pricing of a real-estate property, or the availability of the property. Similarly, if the user is a money lender, then the query may pertain to different kind of loan products. Further, the request may pertain to a request for adding in a user network.

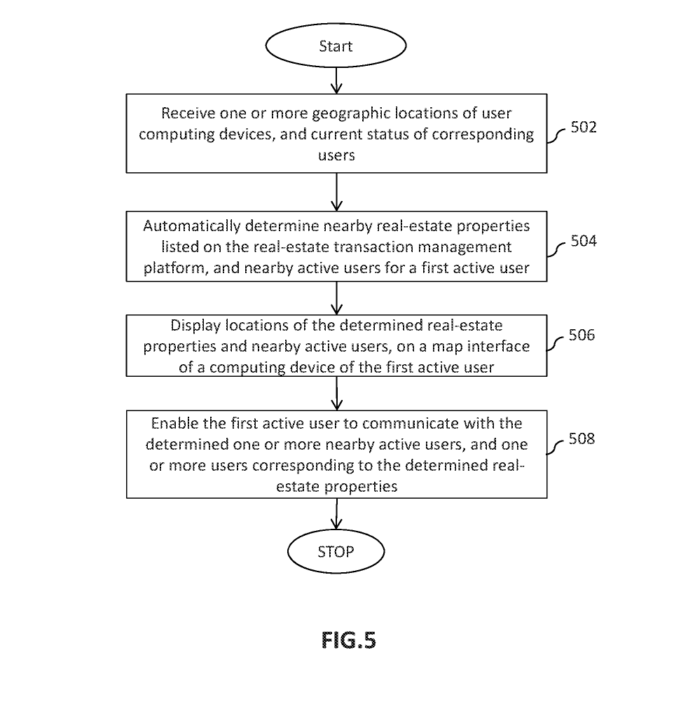

FIG. 5 is a flowchart illustrating a method of connecting one or more users for conducting real-estate transactions, in accordance with an embodiment of the present invention.

At step 502, one or more geographic locations of one or more user computing devices, and current status of the one or more corresponding users are received at a server device.

At step 504, one or more nearby real-estate properties listed on the real-estate transaction management platform, and one or more nearby active users are automatically determined for a first active user by a server device, based on a current geographical location of the first active user, one or more pre-defined preferences of the first user, and a time duration for which the first user is active.

At step 506, one or more locations of the determined one or more real-estate properties and one or more nearby active users are displayed on a map interface of a computing device of the first user.

At step 508, the first user is enabled to communicate with the determined one or more nearby active users, and one or more users corresponding to the determined one or more real-estate properties.

Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples.

What is claimed:

1. A method for connecting one or more users of a real-estate transaction management platform for conducting one or more real-estate transactions, the method comprising:
receiving one or more geographic locations of one or more user computing devices, and current status of the one or more corresponding users;
automatically determining one or more nearby real-estate properties listed on the real-estate transaction management platform, and one or more nearby active users, for a first active user, based on a current geographical location of the first active user, one or more pre-defined preferences of the first active user, and a time duration for which the first user is active;
displaying one or more locations of the determined one or more real-estate properties and one or more nearby active users, on a map interface of a computing device of the first active user; and
enabling the first active user to communicate with the determined one or more nearby active users, and one or more users corresponding to the determined one or more real-estate properties.

2. The method as claimed in claim 1, wherein the receiving one or more geographic locations of the one or more user computing devices comprise receiving corresponding latitude and longitude data associated therein.

3. The method as claimed in claim 1, wherein the first user is a buyer, and the determined one or more nearby active users include a real-estate agent and a money lender.

4. The method as claimed in claim 1, further comprising:
providing a server device that includes:
a memory storing a program; and
a processor for executing the instructions stored in the memory for providing a service application of a real-estate transaction platform on a plurality of user computing devices;
providing a subscription database that is communicatively coupled to the server device, for storing profile details of the one or more buyers, agents, and money lenders subscribed to the real-estate transaction management platform;
providing a real-estate database that is communicatively coupled to the server device for storing a location, a price range, facilities, a number of rooms, one or more images and videos of each real-estate property listed by the real-estate agent;
providing a loan database that is communicatively coupled to the server device for storing one or more loan schemes, and the term and conditions available for the real-estate properties listed by the real-estate agent; and
providing a transaction database that is communicatively coupled to the server device for storing one or more transaction details of the one or more real-estate property transactions.

5. The method as claimed in claim 4 further comprising:
displaying a buyer interface on a display screen of a buyer computing device, the buyer interface enabling a buyer to subscribe to the real-estate transaction management platform by providing an identification proof, preferred property requirements, and browse one or more listed real-estate properties;
displaying an agent interface on a display screen of an agent computing device, the agent interface enabling a real-estate agent to upload one or more details of one or more real-estate properties, and other related information along with agent registration number, and contact details; and
displaying a lender interface on a display screen of a lender computing device, the lender interface enabling a lender to upload details of one or more loan schemes, and term and conditions available for the real-estate properties listed by the real-estate agent.

6. The method as claimed in claim 4, further comprising:
providing a global map unit that is communicatively coupled to the server device for generating a latitude and a longitude data associated with the geographic location of one or more real-estate properties, real-estate agents, lenders and buyers.

7. A system for connecting one or more users of a real-estate transaction management platform for conducting one or more real-estate transactions, the system comprising:
a processor; and
a memory storing a program for execution by the processor, the program including instructions for:
receiving one or more geographic locations of one or more user computing devices, and current status of the one or more corresponding users;
automatically determining one or more nearby real-estate properties listed on the real-estate transaction management platform, and one or more nearby active users, for a first active user, based on a current geographical location of the first active user, one or more pre-defined preferences of the first user, and a time duration for which the first user is active;
displaying one or more locations of the determined one or more real-estate properties and one or more nearby active users, on a map interface of a computing device of the first user; and
enabling the first user to communicate with the determined one or more nearby active users, and one or more users corresponding to the determined one or more real-estate properties.

8. The system as claimed in claim 7, wherein the first user is a buyer, and the determined one or more nearby active users include a real-estate agent and a money lender.

9. The system as claimed in claim 7 further comprising a server device and one or more computing devices communicatively coupled to the server device through a communication network, the one or more computing devices executing a service application of the real-estate transaction management platform provided by the server device.

10. The system as claimed in claim 9, further comprising:
a buyer interface displayed on a display screen of a buyer computing device, the buyer interface enabling a buyer to subscribe to the real-estate transaction management platform by providing an identification proof, preferred property requirements, and browse one or more listed real-estate properties;
an agent interface displayed on a display screen of an agent computing device, the agent interface enabling a real-estate agent to upload one or more details of one or more real-estate properties, and other related information along with agent registration number, and contact details; and
a lender interface displayed on a display screen of a lender computing device, the lender interface enabling a lender to upload details of one or more loan schemes, and term and conditions available for the real-estate properties listed by the real-estate agent.

11. The system as claimed in claim 10, further comprising:
a subscription database for storing profile details of the one or more buyers, agents, and money lenders subscribed to the real-estate transaction management platform;
a real-estate database for storing a location, a price range, facilities, a number of rooms, one or more images and videos of each real-estate property listed by the real-estate agent;
a loan database for storing one or more loan schemes, and the term and conditions available for the real-estate properties listed by the real-estate agent; and
a transaction database for storing one or more transaction details of the one or more real-estate property transactions.

12. The system as claimed in claim 10, further comprising:
a global map unit for generating a latitude and a longitude data associated with the geographic location of one or more real-estate properties, real-estate agents, lenders and buyers.

13. A non-transitory computer readable storage medium storing a program configured to be executed by a processor for connecting one or more users of a real-estate transaction management platform for conducting one or more real-estate transactions, the program comprising instructions for:
receiving one or more geographic locations of one or more user computing devices, and current status of the one or more corresponding users;
automatically determining one or more nearby real-estate properties listed on the real-estate transaction management platform, and one or more nearby active users, for a first active user, based on a current geographical location of the first active user, one or more pre-defined preferences of the first user, and a time duration for which the first user is active;
displaying one or more locations of the determined one or more real-estate properties and one or more nearby active users, on a map interface of a computing device of the first user; and
enabling the first user to communicate with the determined one or more nearby active users, and one or more users corresponding to the determined one or more real-estate properties.

14. The non-transitory computer readable storage medium as claimed in claim 13, wherein the receiving one or more geographic locations of the one or more user computing devices comprise receiving corresponding latitude and longitude data associated therein.

15. The non-transitory computer readable storage medium as claimed in claim 13, wherein the first user is a buyer, and the determined one or more nearby active users include a real-estate agent and a money lender.
